(19) United States
(12) Patent Application Publication
(10) Pub. No.: US 2003/0145381 A1
(43) Pub. Date: Aug. 7, 2003

(54) Support structure for use with patient support

(76) Inventors: Kathryn A. Higdon, Clarkston, MI (US); Michael C. Lah, Goodland, IN (US); Lorena E. Yin, Cleveland Heights, OH (US)

Correspondence Address: BARNES & THORNBURG, 11 SOUTH MERIDIAN, INDIANAPOLIS, IN, 46204

(21) Appl. No.: 10/335,663

(22) Filed: Jan. 2, 2003

Related U.S. Application Data
(60) Provisional application No. 60/345,923, filed on Jan. 3, 2002.

(51) Int. Cl. A61G 7/05; A47C 31/00

(52) U.S. Cl. 5/507.1; 5/658

(57) ABSTRACT

A support structure for supporting equipment and accessories adjacent a patient support is disclosed. The support structure comprises a frame to extend upwardly from the patient support and a shelf attached to the frame to extend over the patient support.

This disclosure claims priority under 35 U.S.C. 119(e) to U.S. Provisional Application No. 60/345,923 which was filed Jan. 3, 2002 and is hereby incorporated by reference herein.

### BACKGROUND

This disclosure relates to structures for supporting equipment and accessories associated with care of patients.

Medical facilities contain a variety of medical equipment and accessories to care for patients. Such equipment and accessories include, for example, intravenous (IV) infusion pumps, IV bags, medical gas equipment, and monitors, to name just a few. Structures are often used to support such equipment and accessories.

### SUMMARY

The present invention comprises one or more of the following features or combinations thereof:

A support structure for supporting equipment and accessories adjacent a patient support is provided. The support structure comprises a frame to extend upwardly from foot end corner portions of the patient support and a shelf attached to the frame to extend over the patient support toward the head end of the patient support.

The frame may comprise a side portion extending upwardly from each foot end corner portion, a transverse portion extending between the side portions, and an upright portion extending upwardly from the transverse portion and between the side portions. The side portions and the upright portion may comprise concave surfaces configured and aligned to carry a tank. The frame may comprise a channel to receive and attach an IV pole to the frame.

The shelf may be attached to the side portions for movement between use and storage positions. The shelf may pivot about 270° when the shelf is pivoted between the use and storage positions. The shelf may rest on an upper end portion of the upright portion when the shelf is in the use position and may be spaced apart from the upper end portion of the upright portion when the shelf is in the storage position. The shelf may be fixed to the side portions against movement.

The frame may comprise an elongated slot adjacent each foot end corner portion. The shelf may comprise a platform, a flange extending from each side of the platform, and a slider pin attached to each flange and extending through the adjacent slot to accommodate movement of the platform between the use and storage positions. Each slider pin may be located in an upper portion of the adjacent slot when the platform is in the use position and may be located in a lower portion of the adjacent slot when the platform is in the storage position.

Additional features and advantages of the present disclosure will become apparent to those skilled in the art upon consideration of the following detailed description exemplifying the best mode as presently perceived.

### BRIEF DESCRIPTION OF DRAWINGS

The detailed description particularly refers to the accompanying figures in which:

FIG. 1 is a perspective view of a support structure attached to a patient support and supporting equipment and accessories;

FIG. 2 is a perspective view of the support structure showing a shelf thereof in a use position;

FIG. 3 is a perspective view of the support structure showing its shelf in a storage position;

FIG. 4 is a side elevation view of the support structure showing its shelf in the use position in solid lines and showing its shelf in the storage position in dashed lines;

FIG. 5 is a front elevation view of the support structure showing its shelf in the use position;

FIG. 6 is a rear elevation view of the support structure showing its shelf in the use position;

FIG. 7 is a rear elevation view of the support structure showing its shelf in the storage position;

FIG. 8 is a bottom view of a platform of the shelf;

FIG. 9 is a sectional view taken along lines 9-9 of FIG. 8;

FIG. 10 is a sectional view taken along lines 10-10 of FIG. 8;

FIG. 11 is a perspective view of another support structure for attachment to the patient support to support equipment and accessories;

FIG. 12 is a perspective view of another support structure for attachment to the patient support to support equipment and accessories;

FIG. 13 is a side elevation view of the support structure of FIG. 12 showing a shelf of the support structure in a use position;

FIG. 14 is a side elevation view of the support structure of FIG. 12 showing the shelf of the support structure in a storage position;

FIG. 15 is a perspective view of another support structure for attachment to the patient support to support equipment and accessories;

FIG. 16 is a perspective view of another support structure for attachment to the patient support to support equipment and accessories; and

FIG. 17 is a perspective view of another support structure for attachment to the patient support to support equipment and accessories.

### DETAILED DESCRIPTION OF DRAWINGS

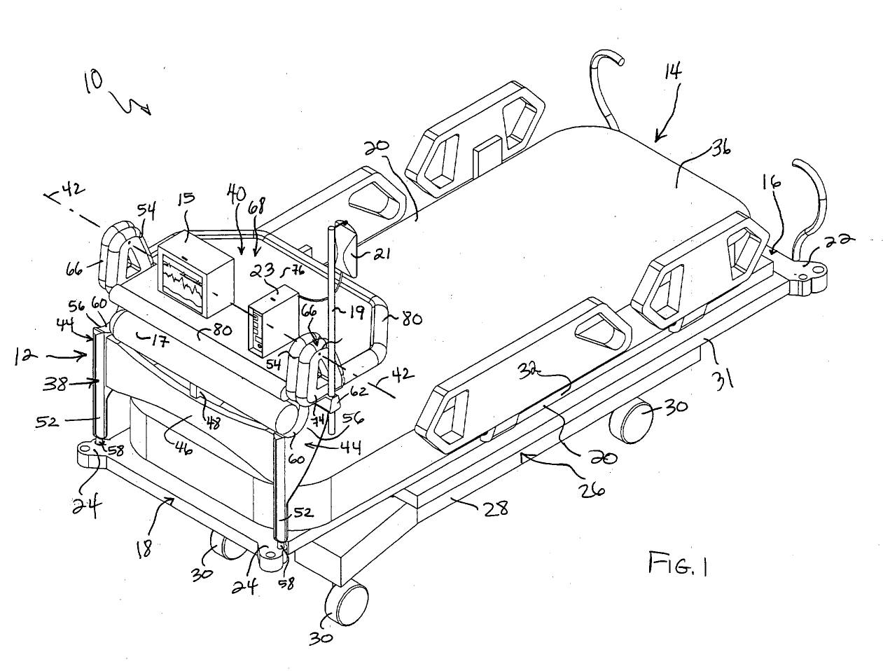

A patient care apparatus 10 comprises a support structure 12 for supporting equipment and accessories associated with care of a patient on a patient support 14, as shown in FIG. 1. The support structure 12 is attachable to the patient support 14 to support the equipment and accessories adjacent the patient on the patient support 14 when the patient support 14 is stationary or during transport of the patient support 14 and the patient thereon about a facility (e.g., a hospital). Examples of such equipment and accessories include a monitor 15, a tank 17 containing medical gas (e.g., oxygen), IV equipment (e.g, an IV pole 19, an IV bag 21 hanging on the IV pole 19, and an infusion pump 23 associated with the IV bag), and/or the like.

The patient support 14 is, for example, a hospital bed and comprises a head end 16, a foot end 18, longitudinally extending sides 20, head end corner portions 22, and foot end corner portions 24, as shown in FIG. 1. The patient support 14 further comprises a frame 26. The frame 26 comprises a base 28 with casters 30 for movement of the patient support 14 along a floor, an intermediate frame 31, an articulating patient support deck 32 mounted on the intermediate frame 31, and a lift mechanism 34 attached to the intermediate frame 31 for moving the intermediate frame 31 and the articulating patient support deck 32 relative to the base 28. A mattress 36 is positioned on the articulating patient support deck 32. Examples of patient supports useful as the patient support 14 are disclosed in U.S. Pat. Nos. 6,336,235; 6,216,293; 6,212,714; 6,279,183; 6,047,424; 6,119,291; 5,940,910; 5,682,631; 5,692,256; 5,715,548; 5,724,685; 5,732,423; 5,745,937; 5,771,511; 5,781,949; and 5,630,238, the disclosures of which are hereby incorporated by reference herein.

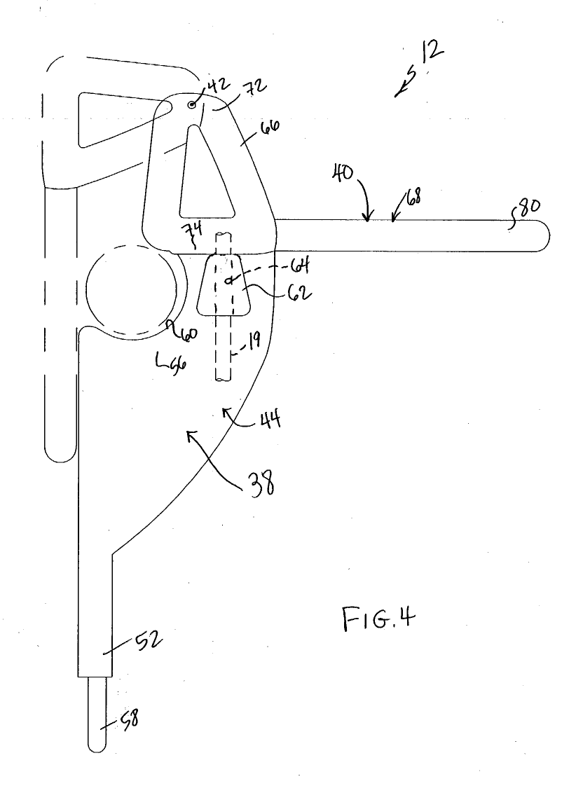

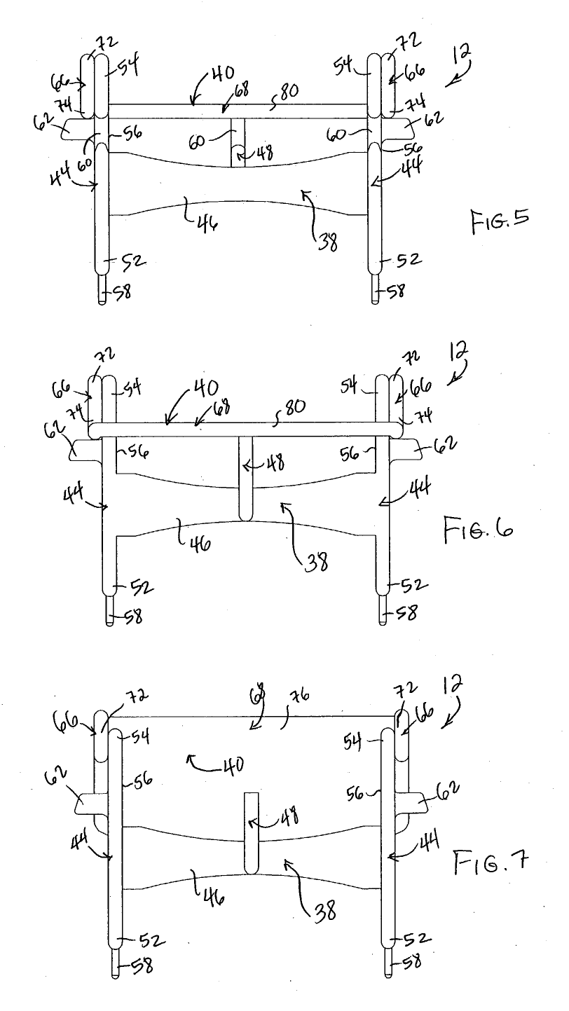

The support structure 12 comprises a frame 38 and a shelf 40, as shown in FIGS. 1-7. The frame 38 is attachable to the foot end corner portions 24 to extend upwardly therefrom and is configured to support the tank 17. The shelf 40 is attached to the frame 38 for movement relative thereto about a horizontal pivot axis 42 between a use position (see FIG.) to support equipment and accessories over the patient support 14 and a storage position (see FIG.).

The frame 38 comprises a pair of side portions 44, a transverse portion 46, and an upright portion 48, as shown in FIGS. 1-3 and 5-7. The side portions 44 attach to and extend upwardly from the foot end corner portions 24. The transverse portion 46 is attached to and extends horizontally between the side portions 44. The upright portion 48 extends upwardly from a central portion of the transverse portion 46. The side portions 44 and the upright portion 48 provide a tank mount configured to support the tank 17 lying down on its side.

Each side portion 44 comprises a lower portion 52, an upper portion 54, and an intermediate portion 56 extending between the lower portion 52 and the upper portion 54, as shown in FIGS. 1-7. The lower portion 52 comprises a lower end, attachment portion 58 to extend into a mounting collar provided on the associated foot end corner portion 24 to mount the support structure 12 to the patient support 14. The intermediate portion 56 extends upwardly from an upper end portion of the lower portion 52 to the upper portion 54. The upright portion 48 is located in a space between the intermediate portions 56.

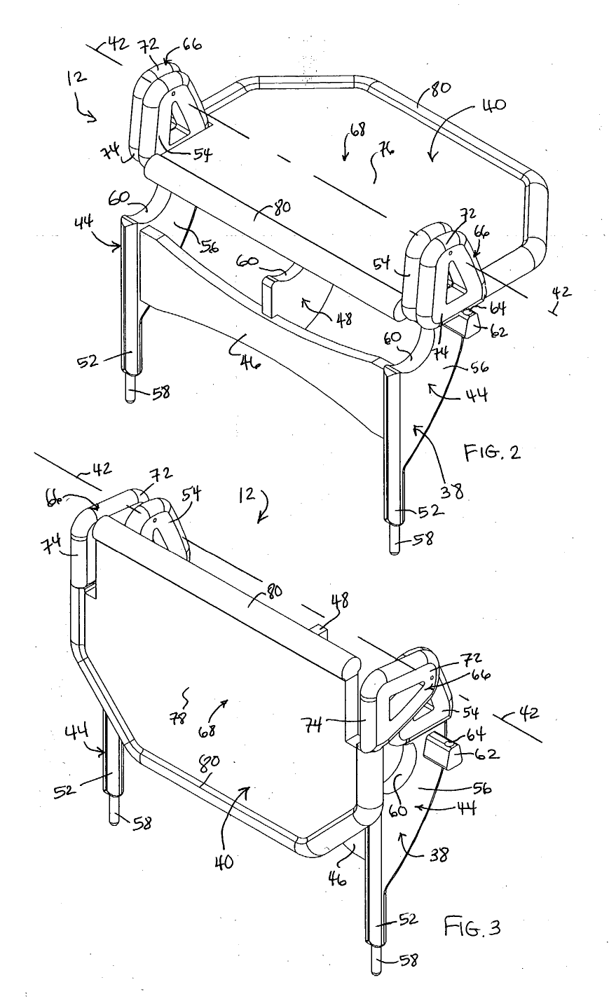

Each of the intermediate portions 56 and the upright portion 48 comprises a concave surface 60, as shown in FIGS. 2 and 5. The concave surfaces 60 are configured and aligned to receive and carry the tank 17 and thus provide the tank mount.

The support structure 12 comprises an IV pole support 62 extending transversely outwardly from each intermediate portion 56 and configured to support an IV pole 19, as shown in FIGS. 1-7. Each IV pole support 62 comprises a channel 64 to receive an associated IV pole 19 for attachment thereof to the frame 38.

The shelf 40 comprises a pair of pivot supports 66 and a platform 68 mounted to the pivot supports 66, as shown in FIGS. 1-7. Each pivot support 66 is attached to one of the upper portions 54 by a pivot pin for movement of the platform 68 about a horizontal pivot axis 42 between the use position in which the platform 68 extends horizontally from the pivot supports 66 toward the head end 16 and the storage position in which the platform 68 extends downwardly from the pivot supports 66. The platform 68 pivots about 270° when the platform 68 is pivoted between the use and storage positions. The upper portions 54 extend upwardly in a space between the pivot supports 66.

Each pivot support 66 comprises a proximal portion 72 and a distal portion 74, as shown in FIGS. 1-7. The proximal portion 72 is pivotally attached to the associated upper portion 54 by one of the pivot pins. The distal portion 74 rests on an upper surface of one of the IV pole supports 62 and is positioned below the proximal portion 72 when the platform 68 is in its use position and is spaced apart from the associated IV pole support 62 and positioned rearwardly from the proximal portion 72 when the platform 68 is in its storage position.

The platform 68 comprises a first surface 76 (see FIGS. 1, 2, 9, and 10) and a second surface 78 (see FIGS. 3 and 8-10). The first surface 76 faces upwardly and the second surface 78 faces downwardly when the platform 68 is in its use position. The first surface 76 faces forwardly toward the transverse portion 46 and the second surface 78 faces rearwardly away from the transverse portion 46 when the platform 68 is in its storage position. The second surface 78 rests on an upper end portion of the upright portion 48 when the platform 68 is in its use position and is spaced apart from the upper end portion of the upright portion 48 when the platform 68 is in its storage position.

The platform 68 comprises a rim 80 that extends around the periphery of the platform 68, as shown in FIGS. 1-7. The rim 80 is configured to inhibit equipment and accessories resting on the first surface 76 from slipping off the first surface 76 when the platform 68 is in its use position.

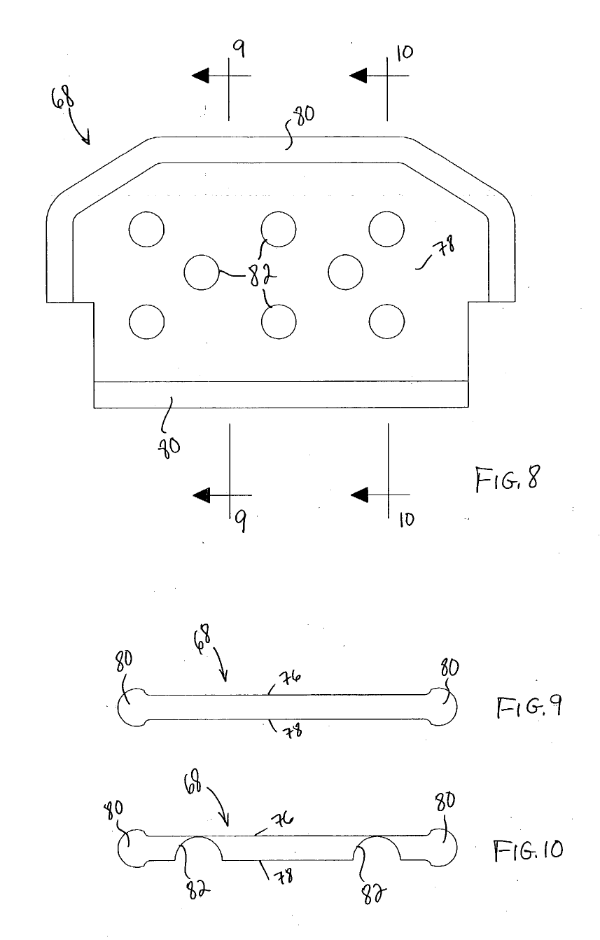

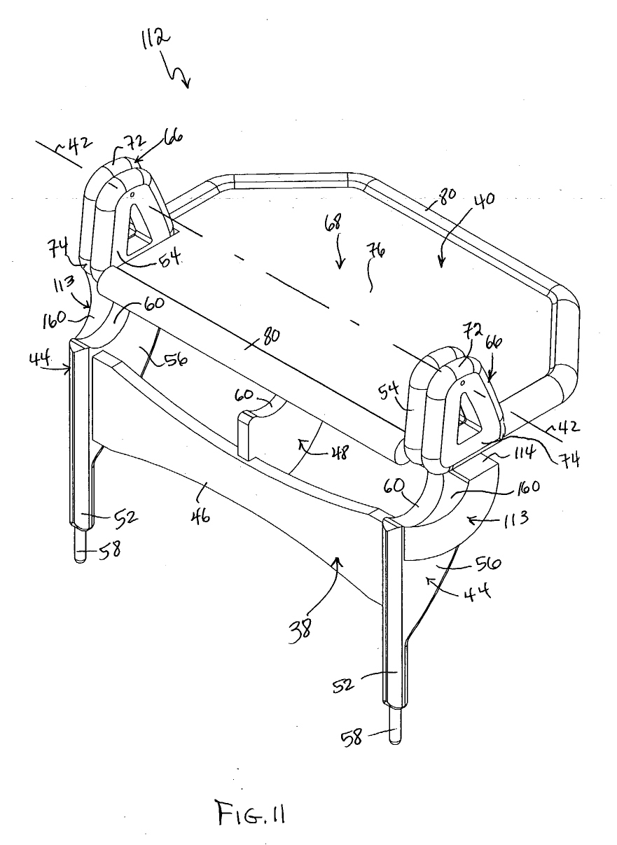

The second surface 78 comprises a plurality of structurally reinforcing tack-offs 82, as shown in FIGS. 8 and 10. The tack-offs 82 are, for example, hemispherical in shape.

Each of the frame 38 and the shelf 40 is, for example, blow-molded to provide a shell made of, for example, polypropylene and comprising an interior cavity. The interior cavities of the shells of the frame 38 and the shelf 40 are injected with foam to increase the density of the frame 38 and the shelf 40 and for sound dampening.

A support structure 112 for use with the patient support 14 to support equipment and accessories associated with care of a patient on the patient support 14 is shown in FIG. 11. The support structure 112 is similar in structure and function to the support structure 12 so that identical reference numbers refer to similar structures.

The support structure 112 comprises a support 113 attached to and extending transversely outwardly from each intermediate portion 56. Each support 113 comprises a concave surface 160 adjacent to a concave surface 60 of the associated intermediate portion 56. The concave surfaces 60, 160 are configured and aligned to receive and carry the tank 17. Further, each support 113 comprises an upper surface 114 upon which an associated distal portion 74 rests when the platform 68 is in its use position.

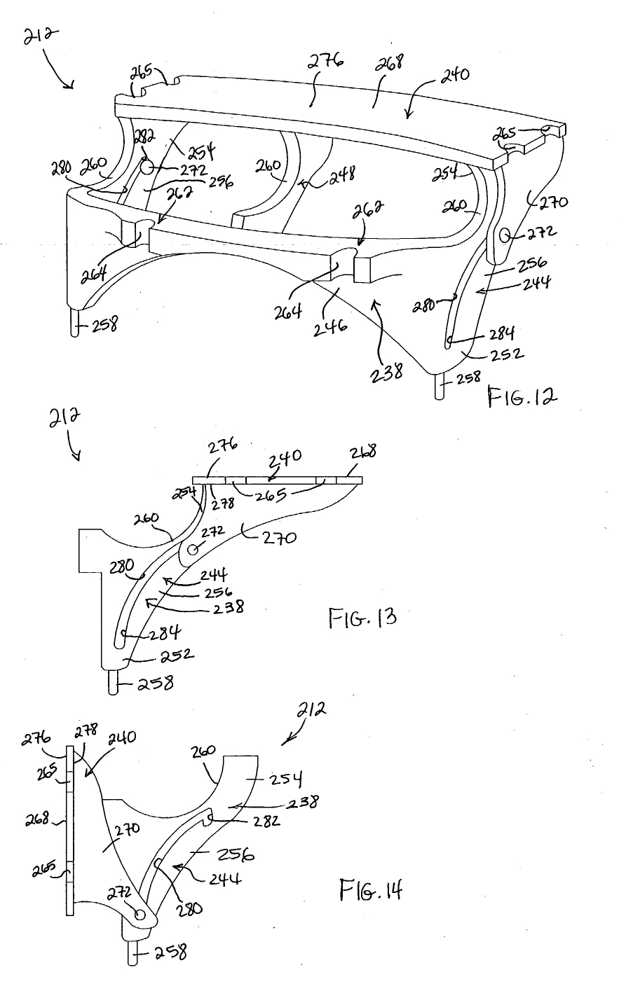

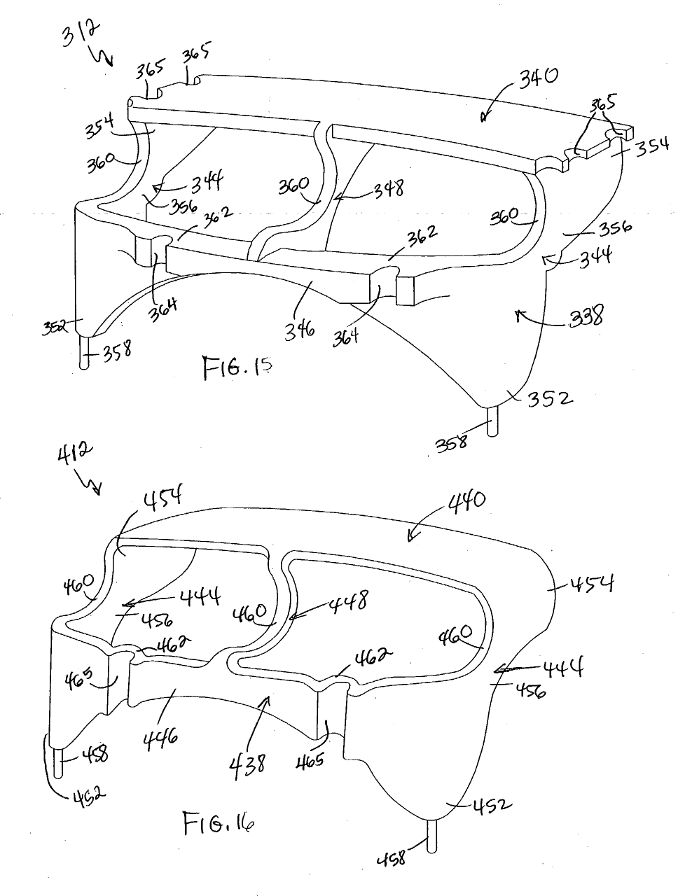

A support structure 212 for use with the patient support 14 to support equipment and accessories associated with care of a patient on the patient support 14 is shown in FIGS. 12-14. The support structure 212 comprises a frame 238 and a shelf 240. The frame 238 is attachable to the foot end corner portions 24 to extend upwardly therefrom and is configured to support the tank 17 lying on its side. The shelf 240 is attached to the frame 238 for movement between a use position (see FIGS. 12 and 13) to support equipment and accessories thereon and a storage position (see FIG. 14).

The frame 238 comprises a pair of side portions 244, a transverse portion 246, and an upright portion 248. The side portions 244 attach to and extend upwardly from the foot end corner portions 24. The transverse portion 246 is attached to and extends horizontally between the side portions 244. The upright portion 248 extends upwardly from a central portion of the transverse portion 246.

Each side portion 244 comprises a lower portion 252, an upper portion 254, and an intermediate portion 256 extending between the lower portion 252 and the upper portion 254. The lower portion 252 comprises a lower end, attachment portion 258 such as a peg to extend into the mounting collar provided on the associated foot end corner portion 24 to mount the support structure 212 to the patient support 14. The intermediate portion 256 extends upwardly from an upper end portion of the lower portion 252 to the upper portion 254. The upright portion 248 is located in a space between the intermediate portions 256.

Each of the intermediate and upright portions 256, 248 comprises a concave surface 260. The concave surfaces 260 are configured and aligned to receive and carry the tank 17.

The transverse portion 246 comprises an IV pole support 262 between each side portion 244 and the upright portion 248. Each IV pole support 262 comprises a channel 264 opening rearwardly to receive an IV pole therein.

The shelf 240 comprises a platform 268, a flange 270 attached to and extending from each side of the platform 268, and a slider pin 272 attached to each flange 270. Each side of the platform 268 illustratively comprises two channels 265 opening transversely outwardly to receive an IV pole. The platform 268 comprises a first surface 276 and a second surface 278. A proximal portion of each flange 270 is attached to the second surface 278 adjacent a side of the platform 268. Each slider pin 272 is attached to a distal portion of the associated flange 270 and extends through a generally vertically extending elongated slot 280 formed in the adjacent side portion 244.

The slider pins 272 are movable in the elongated slots 280 to accommodate movement of the platform 268 between the use position and the storage position. In the use position, each slider pin 272 is located in a recess of an upper portion 282 of the adjacent slot 280 and the platform 268 extends horizontally toward the head end 16. The second surface 278 of the platform 268 rests on the upper portions 254 of the side portions 244 and the upright portion 248 in the use position. In the storage position, each slide pin 272 is located in a lower portion 284 of the adjacent slot 280 and the platform 268 extends vertically downwardly. Further, in the storage position, the first surface 276 faces rearwardly away from the frame 238 and the second surface 278 faces forwardly toward the frame 238.

Each side of the shelf 240 comprises, for example, two channels 265. The channels 265 open transversely outwardly to receive and support an IV pole.

A support structure 312 for use with the patient support 14 to support equipment and accessories associated with care of a patient on the patient support 14 is shown in FIG. 15. The support structure 312 comprises a frame 338 and a shelf 340. The frame 338 is attachable to the foot end corner portions 24 to extend upwardly therefrom and is configured to support the tank 17 lying on its side. The shelf 340 is fixed to the frame 338 to support equipment and accessories and extends toward the head end 16 of the patient support 14.

The frame 338 comprises a pair of side portions 344, a transverse portion 346, and an upright portion 348. The side portions 344 attach to and extend upwardly from the foot end corner portions 24. The transverse portion 346 is attached to and extends horizontally between the side portions 344. The upright portion 348 extends upwardly from a central portion of the transverse portion 346 to a rearward central portion of the shelf 340.

Each side portion 344 comprises a lower portion 352, an upper portion 354, and an intermediate portion 356 extending between the lower portion 352 and the upper portion 354. The lower portion 352 comprises a lower end, attachment portion 358 such as a peg to extend into the mounting collar provided on the associated foot end corner portion 24 to mount the support structure 312 to the patient support 14. The intermediate portion 356 extends upwardly from an upper end portion of the lower portion 352 to the upper portion 354. The upright portion 348 is located in a space between the intermediate portions 356.

Each of the intermediate and upright portions 356, 348 comprises a concave surface 360. The concave surfaces 360 are configured and aligned to receive and carry the tank 17.

The transverse portion 346 comprises an IV pole support 362 between each side portion 344 and the upright portion 348. Each IV pole support 362 comprises a channel 364 opening rearwardly to receive and support an IV pole therein.

The shelf 340 comprises channels 365. Each channel 365 is configured to receive an IV pole.

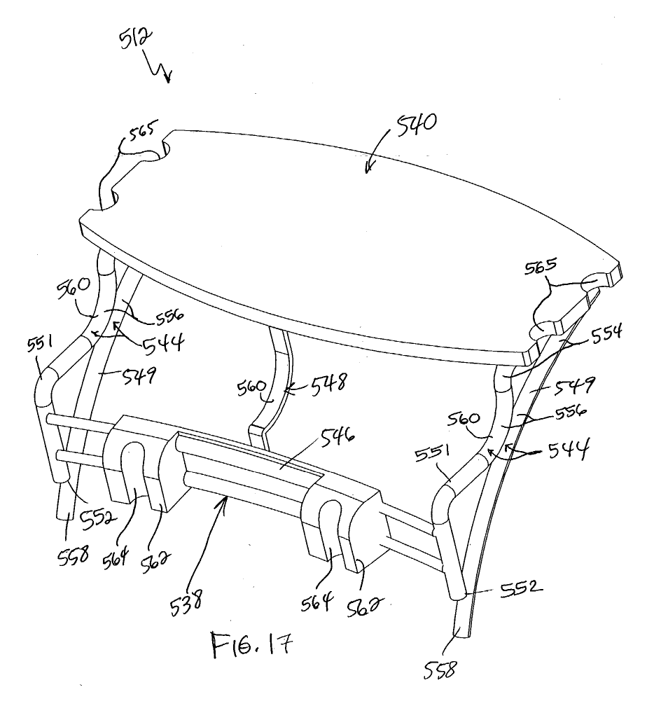

A support structure 412 for use with the patient support 14 to support equipment and accessories associated with care of a patient on the patient support 14 is shown in FIG. 16. The support structure 412 comprises a frame 438 and a shelf 440. The frame 438 is attachable to the foot end corner portions 24 to extend upwardly therefrom and is configured to support the tank 17 lying on its side. The shelf 440 is fixed to the frame 438 to support equipment and accessories and extends toward the head end 16 of the patient support 14.

The frame 438 comprises a pair of side portions 444, a transverse portion 446, and an upright portion 448. The side portions 444 attach to and extend upwardly from the foot end corner portions 24. The transverse portion 446 is attached to and extends horizontally between the side portions 444. The upright portion 448 extends upwardly from a central portion of the transverse portion 446 to a rearward central portion of the shelf 440.

Each side portion 444 comprises a lower portion 452, an upper portion 454, and an intermediate portion 456 extending between the lower portion 452 and the upper portion 454. The lower portion 452 comprises a lower end, attachment portion 458 such as a peg to extend into the mounting collar provided on the associated foot end corner portion 24 to mount the support structure 412 to the patient support 14. The intermediate portion 456 extends upwardly from an upper end portion of the lower portion 452 to the upper portion 454. The upright portion 448 is located in a space between the intermediate portions 456.

Each of the intermediate and upright portions 456, 448 comprises a concave surface 460. The concave surfaces 460 are configured and aligned to receive and carry the tank 17.

The transverse portion 446 comprises an IV pole support 462 positioned between each side portion 444 and the upright portion 448. Each IV pole support 462 comprises a channel 464 opening rearwardly to receive and support an IV pole therein.

A support structure 512 for use with the patient support 14 to support equipment and accessories associated with care of a patient on the patient support 14 is shown in FIG. 17. The support structure 512 comprises a frame 538 and a shelf 540. The frame 538 is attachable to the foot end corner portions 24 to extend upwardly therefrom and is configured to support the tank 17 lying on its side. The shelf 540 is fixed to the frame 538 to support equipment and accessories and extends toward the head end 16 of the patient support 14.

The frame 538 comprises a pair of side portions 544. The side portions 544 attach to and extend upwardly from the foot end corner portions 24.

Each side portion 544 comprises a forward bar 549 and a rearward bar 551. The bars 549, 551 provide the side portion 544 with a lower portion 552, an upper portion 554, and an intermediate portion 556 extending between the lower portion 552 and the upper portion 554. The forward bar 549 provides the lower portion 552 with a lower end, attachment portion 558 to extend into the mounting collar provided on the associated foot end corner portion 24 to mount the support structure 512 to the patient support 14.

The frame 538 comprises a transverse portion 546 extending between the side portions 544. The transverse portion 546 comprises an upper bar 584 and a lower bar 586. The upper and lower bars 584, 586 extend horizontally between and are attached to the rearward bars 551. The transverse portion 546 comprises an IV pole support 562 positioned between each side portion 544 and the upright portion 548. Each IV pole support 562 comprises a channel 564 opening rearwardly to receive and support an IV pole therein. Each side of the shelf 540 also comprises illustratively two channels 565 opening transversely outwardly to receive and support an IV pole.

The frame 538 further comprises an upright portion 548 extending upwardly from a central portion of the upper bar 584 to a rearward central portion of the shelf 540. The upright portion 548 is located in a space between the intermediate portions 556.

Each of the upright portion 548 and the rearward bars 551 comprises a concave surface 560. The concave surfaces 560 are configured and aligned to receive and carry the tank 17.

1. A support structure for supporting equipment and accessories adjacent a patient support comprising a head end, a foot end, longitudinally extending sides, head end corner portions, and foot end corner portions, the support structure comprising:
a frame to extend upwardly from the foot end corner portions, and
a shelf attached to the frame to extend over the patient support toward the head end.

2. The support structure of claim 1, wherein the frame comprises side portions, each side portion comprises a lower portion to extend upwardly from one of the foot end corner portions, an intermediate portion extending upwardly from an upper end portion of the lower portion, and an upper portion extending upwardly from an upper end portion of the intermediate portion, the frame comprising a transverse portion extending between the intermediate portions of the side portions, and the shelf is attached to the upper portions of the side portions to extend over the patient support toward the head end.

3. The support structure of claim 2, wherein the frame comprises an upright portion extending upwardly from the transverse portion in a space between the intermediate portions, each of the intermediate and upright portions comprises a concave surface, and the concave surfaces being configured and aligned to carry a tank.

4. The support structure of claim 1, wherein the shelf is attached to the frame for movement about a pivot axis between a use position in which the shelf extends horizontally toward the head end and a storage position in which the shelf extends vertically.

5. The support structure of claim 4, wherein the shelf pivots about 270° when the shelf is pivoted between the use and storage positions.

6. The support structure of claim 4, wherein the frame comprises an upright portion extending upwardly from the transverse portion, the shelf rests on an upper end portion of the upright portion when the shelf is in the use position, and the shelf is spaced apart from the upper end portion of the upright portion when the shelf is in the storage position.

7. The support structure of claim 1, wherein the frame comprises an elongated slot adjacent each foot end corner portion, and the shelf comprises a platform, a flange extending from each side of the platform, and a slider pin attached to each flange and extending through the adjacent slot to accommodate movement of the platform between a use position in which the platform extends horizontally toward the head end and a storage position in which the platform extends vertically downwardly.

8. The support structure of claim 7, wherein each slider pin is located in an upper portion of the adjacent slot when the platform is in the use position, and each slider pin is located in a lower portion of the adjacent slot when the platform is in the storage position.

9. The support structure of claim 1, wherein the frame comprises a channel to receive an IV pole to attach the IV pole to the frame.

10. A support structure for supporting equipment and accessories adjacent a patient support comprising a head end, a foot end, longitudinally extending sides, head end corner portions, and foot end corner portions, the support structure comprising:
a frame comprising side portions, each side portion comprising a lower portion to extend upwardly from one of the foot end corner portions, an intermediate portion extending upwardly from an upper end portion of the lower portion, and an upper portion extending upwardly from an upper end portion of the intermediate portion, the frame comprising a transverse portion extending between the intermediate portions of the side portions, the frame comprising an upright portion extending upwardly from the transverse portion in a space between the intermediate portions, the intermediate portions and the upright portion being configured to carry a tank, and
a shelf attached to the upper portions of the side portions to extend over the patient support toward the head end.

11. The support structure of claim 10, wherein the frame comprises a pole support extending transversely outwardly from one of the intermediate portions and comprising a channel to receive an IV pole for attachment thereof to the frame.

12. The support structure of claim 10, wherein the transverse portion provides a channel to receive an IV pole to attach the IV pole to the frame.

13. The support structure of claim 10, wherein the shelf comprises a pair of pivot supports and a platform attached to each pivot support, and each pivot support is attached to one of the upper portions of the side portions for movement of the platform about a horizontal pivot axis extending through the pivot supports and the upper portions of the side portions between a use position in which the platform extends horizontally from the pivot supports toward the head end and a storage position in which the platform extends downwardly from the pivot supports.

14. The support structure of claim 13, wherein the platform rests on an upper end portion of the upright portion when the platform is in the use position, and the platform is spaced apart from the upper end portion of the upright portion when the platform is in the storage position.

15. The support structure of claim 13, wherein the platform comprises a first surface and a second surface, the first surface faces upwardly and the second surface faces downwardly when the platform is in the use position, and the first surface faces the transverse portion and the second surface faces away from the transverse portion when the platform is in the storage position.

16. The support structure of claim 13, wherein the platform pivots about 270° when the platform is pivoted between the use and storage positions.

17. The support structure of claim 10, wherein each intermediate portion comprises an elongated slot, and the shelf comprises a platform, a flange extending from each side of the platform, and a slider pin attached to each flange and extending through the adjacent slot to accommodate movement of the platform between a use position in which the platform extends horizontally toward the head end and a storage position in which the platform extends vertically.

18. The support structure of claim 17, wherein each slider pin is located in an upper portion of the associated slot when the platform is in the use position, and each slider pin is located in a lower portion of the associated slot when the platform is in the storage position.

19. The support structure of claim 10, wherein each of the intermediate and upright portions comprises a concave surface, and the concave surfaces are configured and aligned to carry the tank.

20. A patient care apparatus comprising:
a patient support comprising a head end, a foot end, longitudinally extending sides, head end corner portions, and foot end corner portions, and
a support structure to support equipment and accessories adjacent the patient support, the support structure comprising a frame extending upwardly from the foot end corner portions and a shelf attached to the frame and extending over the patient support toward the head end.

21. The support structure of claim 20, wherein the frame comprises side portions, each side portion comprises a lower portion extending upwardly from one of the foot end corner portions, an intermediate portion extending upwardly from an upper end portion of the lower portion, and an upper portion extending upwardly from an upper end portion of the intermediate portion, the frame comprises a transverse portion extending between the intermediate portions of the side portions, and the shelf is attached to the upper portions of the side portions and extends over the patient support toward the head end.

22. The support structure of claim 21, wherein the frame comprises an upright portion extending upwardly from the transverse portion in a space between the intermediate portions, each of the intermediate and upright portions comprises a concave surface, and the concave surfaces are configured to carry a tank.

23. The support structure of claim 21, wherein each lower portion of each side portion is proportioned to extend into a mounting collar provided on each foot end corner portion.

24. The support structure of claim 20, wherein the shelf is attached to the frame for movement about a pivot axis between a use position in which the shelf extends horizontally toward the head end and a storage position in which the shelf extends vertically.

25. The support structure of claim 24, wherein the shelf pivots about 270° when the shelf is pivoted between the use and storage positions.

26. The support structure of claim 24, wherein the frame comprises a side portion extending upwardly from each foot end corner portion, a transverse portion extending between the side portions, and an upright portion extending upwardly from the transverse portion, and the shelf is attached to the side portions for movement about the pivot axis between the use and storage positions, rests on an upper end portion of the upright portion when the shelf is in the use position, and is spaced apart from the upper end portion of the upright portion when the shelf is in the storage position.

27. The support structure of claim 20, wherein the frame comprises an elongated slot adjacent each foot end corner portion, and the shelf comprises a platform and a slider pin extending through each slot to support the platform for movement of the platform between a use position in which the platform extends horizontally toward the head end and a storage position in which the platform extends vertically.

28. The support structure of claim 27, wherein each slider pin is located in an upper portion of the associated slot when the platform is in the use position, and each slider pin is located in a lower portion of the associated slot when the platform is in the storage position.

29. The support structure of claim 20, wherein the frame comprises a channel to receive an IV pole to attach the IV pole to the frame.
